(19) United States
(12) Patent Application Publication
(10) Pub. No.: US 2007/0234858 A1
(43) Pub. Date: Oct. 11, 2007

(54) UNIVERSAL FLAT CABLE JACKET SLITTER

(75) Inventors: Robert W. Sullivan, Simi Valley, CA (US); John DiCaprio, N. Hollywood, CA (US); John Miller, Arlington, TX (US)

Correspondence Address: MCDERMOTT WILL & EMERY LLP, 2049 CENTURY PARK EAST, 38th Floor, LOS ANGELES, CA, 90067-3208, US

(73) Assignee: SullStar Technologies Inc.

(21) Appl. No.: 11/423,805

(22) Filed: Jun. 13, 2006

Related U.S. Application Data
(60) Provisional application No. 60/744,326, filed on Apr. 5, 2006.

(51) Int. Cl. H02G 1/12; B21F 13/00; B26B 27/00

(52) U.S. Cl. 83/13; 30/90.4; 30/90.8

(57) ABSTRACT

A flat cable jacket slitter including a housing, a longitudinal channel within the housing sized to allow the cable to be moved longitudinally within the channel, a cutting blade within the housing, and a movable cam. The movable cam may be positioned within the housing and configured to move between a threading position that allows the cable to be easily moved longitudinal within the channel without substantially engaging the cutting blade and a cutting position that causes the cutting blade to cut a longitudinal slit into an edge of the jacket when the cable is moved longitudinally within the channel. The movable cam may form a longitudinal sub-channel within the housing. The sub-channel may be co-aligned with the longitudinal channel, sized to allow the cable to be moved longitudinally within the sub-channel, have a width that is smaller than the width of the longitudinal channel during operation of the cable jacket slitter, and have a length that is substantially shorter than the length of the longitudinal channel.

### CROSS-REFERENCE TO RELATED APPLICATION

This application claims priority to and the benefit of the filing date of U.S. Provisional Application Ser. No. 60/744,326, entitled “Universal Radial Jacket Slitter,” filed Apr. 5, 2006, the entire content of which is incorporated herein by reference.

### BACKGROUND

1. Field

Apparatus and methods for removing jackets on cables.

2. Description of Related Art

Cable jackets often need to be removed from the end of cables during installation or repairs. For certain flat fiber optic cables, 18-20 inches of the jacket often needs to be removed.

To accomplish this, a technician often cuts through the cable jacket using an open-faced knife. However, this can be difficult, requiring skill, concentration, and strength, particularly when the jacket is made of hard material and a long length of it must be removed. The process can cut too deeply, causing damage to the core of the cable. An optical fiber can also be damaged by excessive cable twisting. The knife can also slip, causing injury to the technician and/or his or her surroundings.

### SUMMARY

A flat cable jacket slitter may include a housing, a longitudinal channel within the housing sized to allow the cable to be moved longitudinally within the channel, a cutting blade within the housing, and a movable cam. The movable cam may be positioned within the housing and configured to move between a threading position that allows the cable to be easily moved longitudinal within the channel without substantially engaging the cutting blade and a cutting position that causes the cutting blade to cut a longitudinal slit into an edge of the jacket when the cable is moved longitudinally within the channel.

A flat cable jacket slitter may include a housing, a longitudinal channel within the housing sized to allow the cable to be moved longitudinally within the channel, and a longitudinal sub-channel within the housing. The sub-channel may be co-aligned with the longitudinal channel, sized to allow the cable to be moved longitudinally within the sub-channel, have a width that is smaller than the width of the longitudinal channel during operation of the cable jacket slitter, and have a length that is substantially shorter than the length of the longitudinal channel. A cutting blade may be positioned within the housing and oriented to cut a longitudinal slit into an edge of the jacket when the cable is moved longitudinally within the channel.

A process for longitudinally slitting a jacket of a flat cable may include inserting the cable into a longitudinal channel, pushing a cutting blade into an edge of the jacket, and removing the cable from the longitudinal channel while the cutting blade is pushed into the edge of the jacket.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 illustrates a cut end of a flat fiber optic cable.

FIGS. 2(a)-(c) illustrate a cable jacket slitter being used to longitudinally slit the jacket from the end the flat cable shown in FIG. 1.

FIG. 3 is a side profile of the cable jacket slitter shown in FIG. 1.

FIGS. 4(a) and (b) illustrate further steps in the removal of the jacket from the end of the flat cable shown in FIG. 1.

FIGS. 5(a) and (b) are interior views of a portion of the cable jacket slitter shown in FIG. 1, showing a movable cam in different positions.

FIGS. 6 (a) and (b) illustrate two portions of the movable cam shown in FIGS. 5(a) and (b) and a cutting blade internal to it.

FIG. 7 is a cut-away view of FIG. 5(b) taken along the line A-A′, with the flat cable illustrated in FIG. 1 within the cable jacket slitter.

FIG. 8 is an interior view of another portion of the cable jacket slitter shown in FIG. 1.

### DETAILED DESCRIPTION

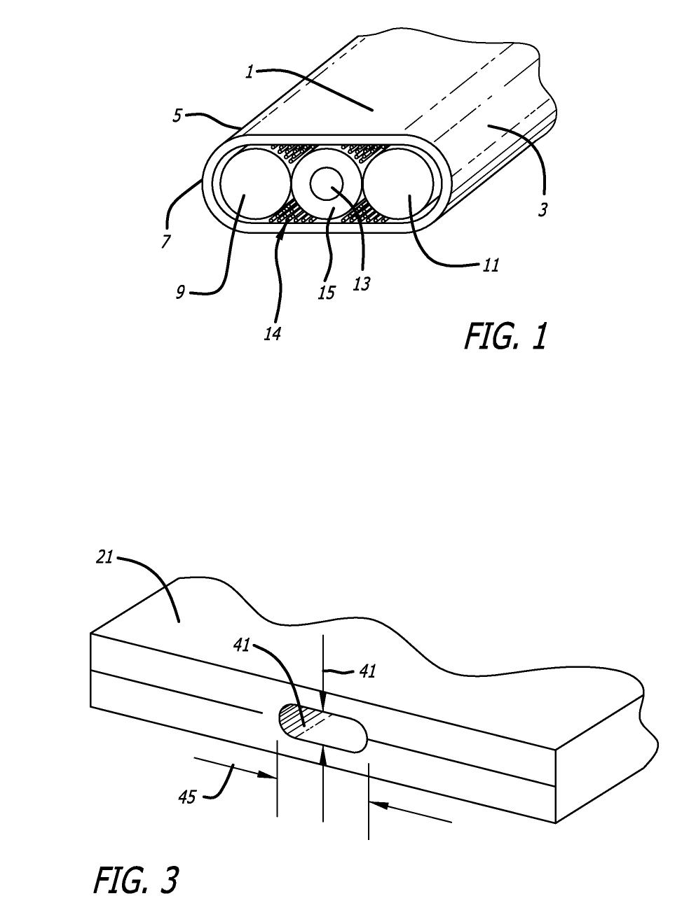

FIG. 1 illustrates a cut end of a flat fiber optic cable. As shown in FIG. 1, a flat fiber optic cable 1 may include a cable edge 3, an opposing cable edge 5, a jacket 7, substantially-rigid stringers 9 and 11 to prevent the cable 1 from bending excessively, and an optical fiber 13 protected by a protective sheet 15. The cable 1 may also include threads 14 to resist stretching of the cable, such as nylon threads.

Although the cable 1 is illustrated in FIG. 1 as being substantially flat, the cable 1 may have any type of cross-section. For example, the cable 1 may be oval, rectangular, or round. It may have a different core construction, such as a greater or lesser number of optical fibers and/or stringers. It may instead or in addition include wires that carry electrical signals and/or power, including one or more shielded conductors.

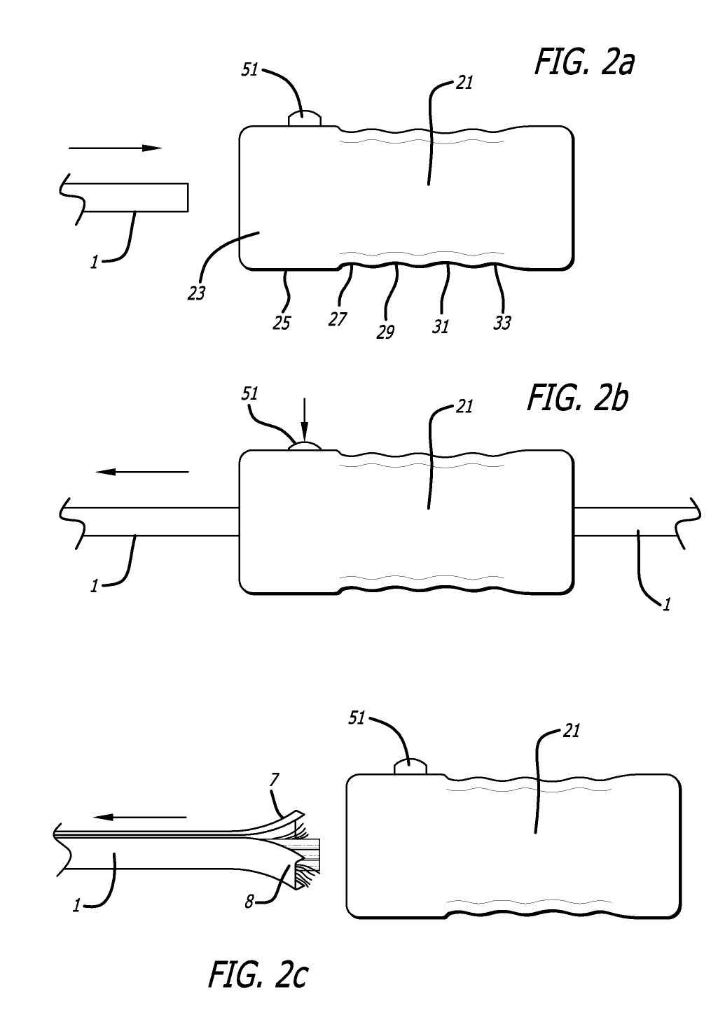

FIGS. 2(a)-(c) illustrate a cable jacket slitter being used to longitudinally slit the jacket from the end of the flat cable shown in FIG. 1. As shown in FIG. 2, a cable jacket slitter 21 may be sized to comfortably be held within a human hand. The cable jacket slitter 21 may include a housing 23. The housing 23 may include a side 25 that includes a plurality of scalloped surfaces 27, 29, 31, and 33. The scalloped surfaces 27, 29, 31, and 33 may be sized and oriented to comfortably seat the fingers of a typical hand. Although four scalloped surfaces are shown in FIGS. 2(a)-(c), a different number may be used. The cable jacket slitter 21 may also be constructed with no scalloped surfaces.

FIG. 3 is a side profile of the cable jacket slitter shown in FIG. 1. As shown in FIG. 3, the cable jacket slitter 21 may include a longitudinal channel 41. The longitudinal channel 41 may have a cross-section that is large enough to accommodate a variety of different cable widths and thicknesses. The thickness 43 of the longitudinal channel 41 may be less than the width 45 of the longitudinal channel 41, so as to conform to the cross-section of a substantially flat cable. The thickness 43 may be great enough to accommodate the anticipated thickness of all flat cables that are intended to be handled by the cable jacket slitter 21, but less than the width of the narrowest of those cables. This may ensure that the cable is unable to rotate within the cable jacket slitter 21.

FIG. 2(a) illustrates the end of the flat cable 1 being inserted into the longitudinal channel 41 (as shown in FIG. 3). This may be accomplished by holding the cable jacket slitter 21 in one hand, by holding the end of the cable 1 in the other hand, and by moving the hands together while aligning the end of the cable 1 with the longitudinal channel 41 (as shown in FIG. 3). The end of the cable 1 may continue to be inserted through the longitudinal channel and out the other end of the cable jacket slitter 21, as shown in FIG. 2(b). The amount by which the end of the cable 1 protrudes beyond the end of the cable jacket slitter 21 may depend upon the amount of jacket that is sought to be removed. In one type of installation, the protruding amount may be adjusted so as to cause approximately 18-20 inches of jacket to be removed. This may be approximated by measuring the distance between a protruding tab 51 and the end of the cable to the right of FIG. 2(b) (not visible in the figure).

After the desired length of the cable 1 is fed through the longitudinal channel 41 in the cable jacket slitter 21, the protruding tab 51 may be moved from a threading position to a cutting position by depressing it, as shown in FIG. 2(b). This may be accomplished by pressing the thumb of the hand that is holding the cable jacket slitter 21 firmly against the protruding tab 51 until the protruding tab 51 moves from the position shown in FIG. 2(a) to the position shown in FIG. 2(b).

At this point, and while still pressing down on the protruding tab 51, the cable 1 may be removed from the cable jacket slitter 21 by pulling the hands apart. This may move the end of the cable 1 during this cutting phase in a direction with respect to the cable jacket slitter 21 that is opposite the direction that the end of the cable 1 is moved during the threading phase illustrated in FIG. 2(a).

The cutting phase may end after the end of the cable 1 is completely removed from the longitudinal channel 41 (shown in FIG. 3) of the cable jacket slitter 21, following which pressure on the protruding tab 51 may be released, as shown in FIG. 2(c). The jacket 7 on the cable 1 may now be longitudinally slit at its end, as illustrated in FIG. 2(c).

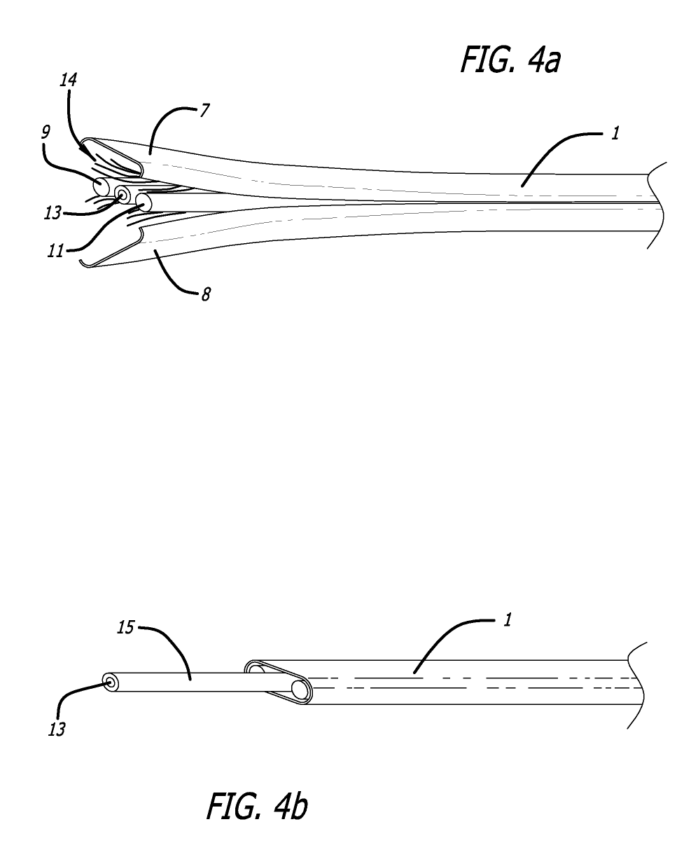

FIGS. 4(a) and (b) illustrate further steps in the removal of the jacket from the end of the flat cable shown in FIG. 1. As shown in FIG. 4(a), split ends 7 and 8 of the jacket may be separated, thus better exposing the inner core of the cable 1, such as its stringers 9 and 11 and its optical fiber 13. The slit ends 7 and 8 may then be cut off, along with the exposed portions of the stringers 9 and 11. This may result in the optical fiber 13 and its protective sheath 15 protruding by itself from the end of the fiber optic cable 1, as shown in FIG. 4(b). (Although not shown, exposed strengthening threads 14 may also be cut off.)

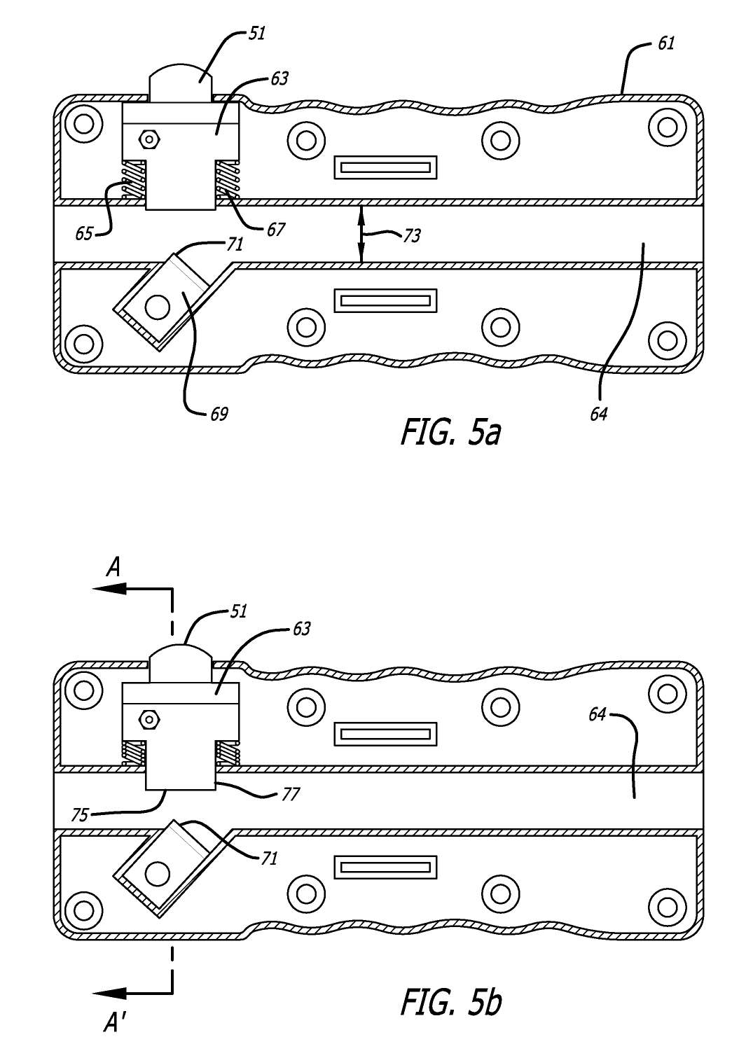

FIGS. 5(a) and (b) are interior views of a portion of the cable jacket slitter shown in FIG. 1, showing a movable cam in different positions. The cable jacket slitter may include a housing portion 61 containing a channel portion 64 of the longitudinal channel 41 (shown in FIG. 3), a movable cam 63 that includes the protruding tab 51, springs 65 and 67, and a cutting blade 69 having a cutting edge 71.

The housing portion 61 may be made of any material, such as metal, plastic, or wood. When made of plastic, any type of plastic may be used, such as ABS.

The cutting blade 69 may be attached to the housing portion 61 using glue, one or more screws, a molding process, other means, and/or any combination of these. The cutting blade 69 may be oriented so that its cutting edge 71 forms an angle of between 125° and 145° with respect to the channel portion 64, such as approximately 135° angle. The cutting blade 69 may be made of any material, such as stainless steel. The cutting edge 71 may be tipped with carbon or diamond or other hard material.

The movable cam 63 may be made of any material, such as one or more of the types of material by which the housing portion 61 is made.

The springs 65 and 67 may be configured and oriented so as to urge the movable cam 63 into a threading position when no force is applied to its protruding tab 51, as illustrated in FIG. 5(a). In this threading position, the width 73 of the channel portion 64 may be substantially the same throughout its length, except for the protrusion of a portion of the edge 71 into the channel 64. In this threading position, there may still be enough room between the edge 71 and the movable cam 63 so as to allow the cable 1 to be threaded through the channel portion 64 without the cable engaging any portion of the edge 71.

Through the application of pressure on the protruding tab 51, the movable cam 63 may be moved into a cutting position, as shown in FIG. 5(b). In this position, an end 75 of the movable cam 63 may push the cable 1 (when within the channel potion 64) into the cutting blade edge 71. The amount of movement between the threading position shown in FIG. 5(a) and the cutting position shown in FIG. 5(b) may be controlled by the amount of force that is applied to the protruding tab 51. The technician may apply an amount of force that is necessary to cause the cutting blade 71 to cut through the jacket 7, but not significantly into the core of the cable 1. Thus, the force that is applied to the protruding tab 51 may be regulated to cause the movable cam 63 to move an amount that is appropriate for the width of the particular cable 1 that is being slit.

Various types of ratcheting and/or other mechanisms (not shown) may be used to regulate the movement of the movable cam 63 between its threading and cutting positions. For example, the cable jacket slitter may include a setting control that regulates the amount of this movement based upon a user-made selection of the type of cable that is being slit.

The movable cam 63 and the housing portion 61 may be configured with a releasable locking mechanism (not shown) that holds the movable cam 63 in the cutting position after it is placed there by the user, as shown in FIG. 5(b). Thereafter, the cable 1 may be withdrawn from the cable jacket slitter 21, as shown in FIG. 2(b), without having to maintain pressure on the protruding tab 51. The locking mechanism may then be unlocked, causing the movable cam 63 to return to the threading position. Any type of releasable locking mechanism may be used.

When the movable cam 63 is in the cutting position, as shown in FIG. 5(b), the movable cam may form a sub-channel 77 that has a length that is substantially less than the length spanned by the channel portion 64 between its entry and exit points. The substantially smaller length of the sub-channel 77 may minimize the surface area that presses against the cable 1 when within the channel. This may minimize the frictional forces that are placed on the cable 1 when the movable cam 63 is in the cutting position and, as a consequence, the amount of force that is needed to withdraw the cable 1 from the cable jacket slitter 21 when the slit is cut.

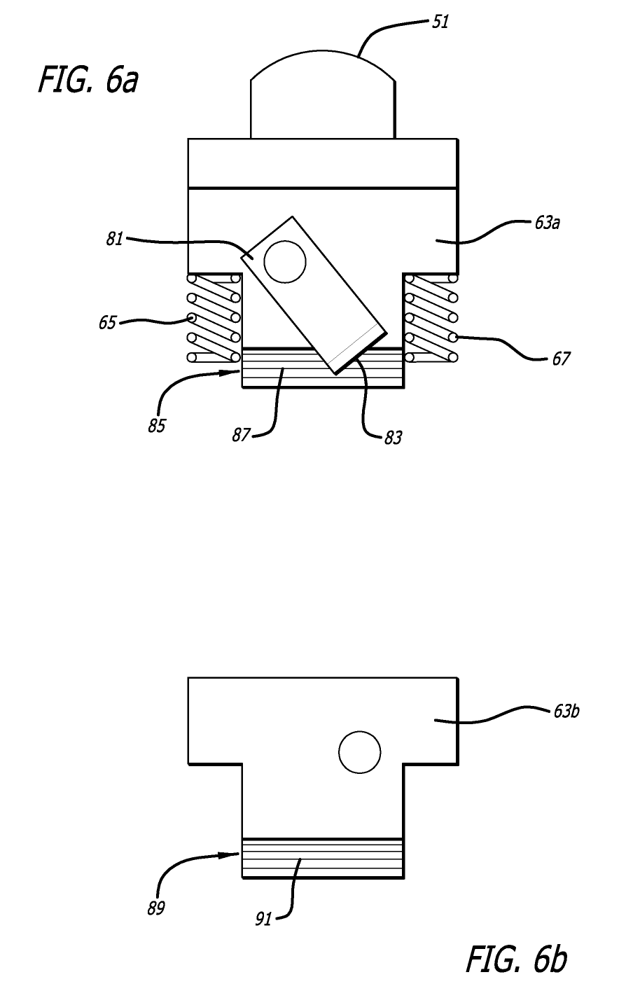

FIGS. 6(a) and (b) illustrate two portions of the movable cam shown in FIGS. 5(a) and (b) and a cutting blade internal to it. As shown in FIG. 6(a), one movable cam portion 63a may have a second cutting blade 81 attached to it. The attachment may be by any means, including any of the means discussed above in connection with the attachment of the cutting blade 69 to the housing portion 61. The second cutting blade 81 may have a cutting edge 83 that may form an angle of between 125° to 145° with respect to the channel portion 64, such as an angle of approximately 135° degrees.

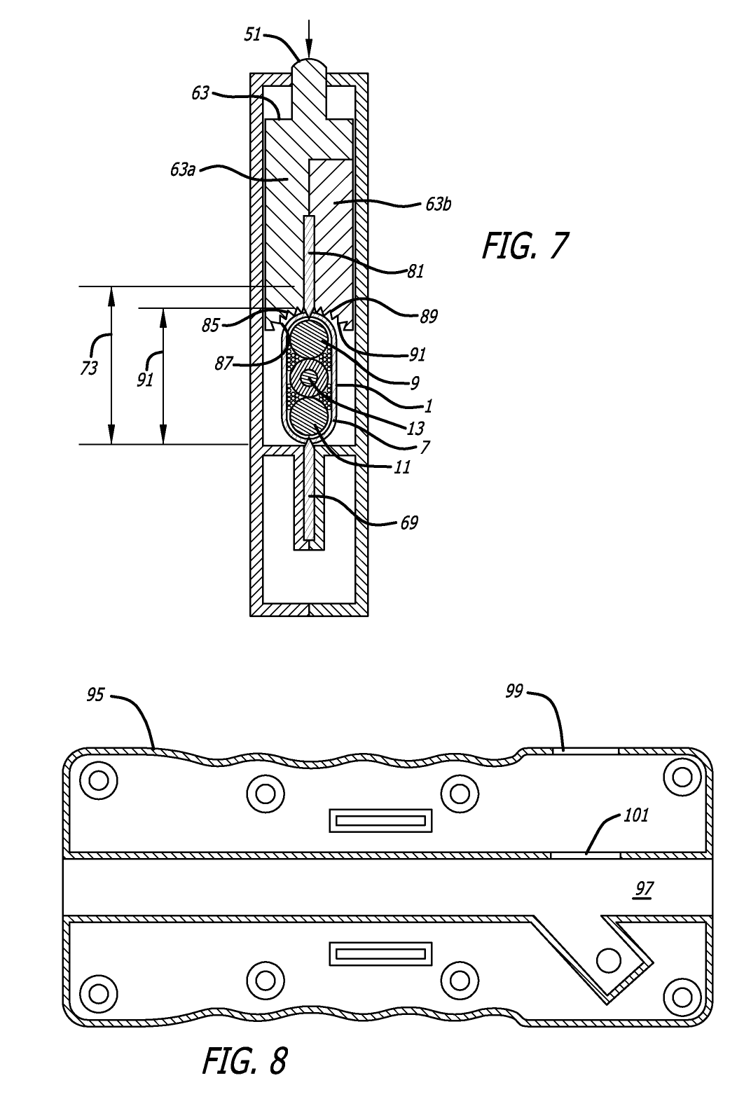

The movable cam portion 63a may include a scalloped surface 85 having a plurality of longitudinal ridges 87 (which may be seen more clearly in FIG. 7). Similarly, a movable cam portion 63b may have a scalloped portion 89 with longitudinal ridges 91 (again, which may be seen more clearly in FIG. 7). The longitudinal ridges 87 and 91 may aid in minimizing surface contact between the cable 1 and the cable jacket slitter, thus minimizing friction and reducing the force that is needed to withdraw the cable 1 from the cable jacket slitter while the movable cam 63 is in the cutting position. The portions 63a and 63b of the movable cam 63 may be attached to one another using any means, such as glue, one or more screws, interlocking tabs, and/or any other means.

FIG. 7 is a cut-away view of FIG. 5(b) taken along the line A-A′, with the flat cable illustrated in FIG. 1 within the cable jacket slitter. As shown in FIG. 7, the movable cam 63 is in its cutting position, with the cutting blades 69 and 81 piercing the jacket 7 of the flat fiber optic cable 1. The scalloped surfaces 85 and 89 may engage the cable 1 through the longitudinal ridges 87 and 91, respectively. This may prevent the cable 1 from rotating while within the longitudinal channel, thus insuring that the cutting blades 69 and 81 cut into the edges of the cable 1 as the cable 1 is withdrawn from the cable jacket slitter.

As also illustrated in FIG. 7, the width 91 of the longitudinal sub-channel 77 (shown in FIG. 5b) may be less than the width 73 of the channel potion 64 (shown in FIG. 5b) while the movable cam 63 is in the cutting position. As explained above, this may help reduce the amount of surface area that is pressed against the cable 1 while it is being withdrawn, while still ensuring that the cable 1 does not twist during the cutting process. The longitudinal sub-channel 77 may be co-aligned with the channel portion 64.

FIG. 8 is an interior view of another portion of the cable jacket slitter shown in FIG. 1. This may include a housing portion 95 that may be substantially symmetrical to the housing portion 61 shown in FIGS. 5(a) and (b). A channel potion 97 may cooperate with the channel portion 64 in FIGS. 5(a) and (b) to form the longitudinal channel 41 shown in FIG. 3. The housing portion may include slots 99 and 101 that cooperate with corresponding slots in the housing portion 61 to house the movable cam 63.

The housing portion 95 may be attached to the housing portion 61 shown in FIGS. 5(a) and (b) using any means, such as one or more screws, glue, welding, interlocking tabs, and/or any combination of these means. The housing portion 95 may be made of any material, such as the same material as the housing portion 61 shown in FIGS. 5(a) and (b).

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

For example, although two cutting blades have been shown, the cable jacket slitter may be configured with only a single cutting blade. In this instance, only one edge of the jacket may be slit after inserting the cable end into and withdrawing it from the cable jacket slitter. To slit the other edge, the end of the cable may be rotated by 180° and reinserted into and withdrawn from the cable jacket slitter for a second time.

Similarly, although the housing and movable cam have both thus-far been illustrated as comprising two sub-potions, either one or both may instead be comprised of a single integral piece more than two sub-potions.

Although the cable jacket slitter has been thus-far illustrated as having a cam that moves from a threading to a cutting position, the movable cam may instead be eliminated and one or more cutting blades may be permanently oriented in the cutting position. In this embodiment, the jacket of the cable may automatically be cut as the cable is inserted and/or withdrawn from the cable jacket slitter.

In short, the scope of protection is limited solely by the claims that now follow. That scope is intended to be as broad as is reasonably consistent with the language that is used in the claims and to encompass all structural and functional equivalents. Nothing that has been stated or illustrated is intended to cause a dedication of any component, step, feature, object, benefit, advantage, or equivalent to the public, regardless of whether it is recited in the claims.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

We claim:

1. A flat cable jacket slitter comprising:
a housing;
a longitudinal channel within the housing sized to allow the cable to be moved longitudinally within the channel;
a cutting blade within the housing; and
a movable cam positioned within the housing and configured to move between a threading position that allows the cable to be easily moved longitudinal within the channel without substantially engaging the cutting blade and a cutting position that causes the cutting blade to cut a longitudinal slit into an edge of the jacket when the cable is moved longitudinally within the channel.

2. The flat cable jacket slitter of claim 1 wherein the housing is sized to be comfortably held within a human hand.

3. The flat cable jacket slitter of claim 2 wherein the housing has a side having a plurality of scalloped surfaces sized and oriented to seat fingers on the hand.

4. The flat cable jacket slitter of claim 2 wherein the movable cam includes a protruding tab that is sized and positioned to allow the movable cam to move from the threading position to the cutting position in response to pressure from the thumb of the human hand while the housing is being held by the human hand.

5. The flat cable jacket slitter of claim 1 wherein the cross-section of the longitudinal channel has a length that is longer than its width.

6. The flat cable jacket slitter of claim 1 wherein the cutting blade is attached to the movable cam.

7. The flat cable jacket slitter of claim 1 wherein the cutting blade is not attached to the movable cam.

8. The flat cable jacket slitter of claim 1 further comprising a second cutting blade oriented within the housing to cut a longitudinal slit into an opposing edge of the jacket when the movable cam is in the cutting position and the cable is moved longitudinally within the channel.

9. The flat cable jacket slitter of claim 8 wherein one of the cutting blades is attached to the movable cam and one is not.

10. The flat cable jacket slitter of claim 1 wherein the cam includes a scalloped surface oriented to engage an edge of the cable while the cable is moved longitudinally within the channel and the movable cam is in the cutting position.

11. The flat cable jacket slitter of claim 10 wherein the scalloped surface includes a plurality of longitudinal ridges running parallel to the longitudinal axis of the longitudinal channel.

12. The flat cable jacket slitter of claim 1 further comprising at least one spring oriented within the housing to urge the movable cam into the threading position.

13. The flat cable jacket slitter of claim 1 wherein the cutting blade has a cutting edge that is oriented within the housing such that the angle between the cutting edge and the longitudinal channel is between 125° and 145°.

14. A cable jacket slitter comprising:
a housing;
a longitudinal channel within the housing sized to allow the cable to be moved longitudinally within the channel;
a cutting blade within the housing; and
a movable cam positioned within the housing and configured to move between a threading position that allows the cable to be easily moved longitudinal within the channel without substantially engaging the cutting blade and a cutting position that causes the cutting blade to cut a longitudinal slit into the jacket when the cable is moved longitudinally within the channel.

15. A flat cable jacket slitter comprising:
a housing;
a longitudinal channel within the housing sized to allow the cable to be moved longitudinally within the channel;
a longitudinal sub-channel within the housing that is co-aligned with the longitudinal channel, that is sized to allow the cable to be moved longitudinally within the sub-channel, that has a width that is smaller than the width of the longitudinal channel during operation of the cable jacket slitter, and that has a length that is substantially shorter than the length of the longitudinal channel; and
a cutting blade positioned within the housing and oriented to cut a longitudinal slit into an edge of the jacket when the cable is moved longitudinally within the channel.

16. The flat cable jacket slitter of claim 15 wherein the housing is sized to be comfortably held within a human hand.

17. The flat cable jacket slitter of claim 16 wherein the housing has a side that includes a plurality of scalloped surfaces sized and oriented to seat fingers on the hand.

18. The flat cable jacket slitter of claim 15 further comprising a second cutting blade oriented within the longitudinal sub-channel to cut a longitudinal slit into an opposing edge of the jacket when the cable is moved longitudinally within the channel.

19. The flat cable jacket slitter of claim 15 wherein the longitudinal sub-channel includes a scalloped surface oriented to engage an edge of the cable while the cable is moved longitudinally within the channel.

20. The flat cable jacket slitter of claim 19 wherein the scalloped surface includes a plurality of longitudinal ridges running parallel to the longitudinal axis of the longitudinal channel.

21. The flat cable jacket slitter of claim 15 wherein the cutting blade has a cutting edge that is oriented within the housing such that the angle between the cutting edge and the longitudinal channel is between 125° and 145°.

22. The flat cable jacket slitter of claim 15 wherein the cutting blade is within the sub-channel.

23. A cable jacket slitter comprising:
a housing;
a longitudinal channel within the housing sized to allow the cable to be moved longitudinally within the channel;
a longitudinal sub-channel within the housing that is co-aligned with the longitudinal channel, that is sized to allow the cable to be moved longitudinally within the sub-channel, that has a width that is smaller than the width of the longitudinal channel during operation of the cable jacket slitter, and that has a length that is substantially shorter than the length of the longitudinal channel; and
a cutting blade positioned within the housing and oriented to cut a longitudinal slit into the jacket when the cable is moved longitudinally within the channel.

24. A process for longitudinally slitting a jacket a flat cable comprising:
inserting the cable into a longitudinal channel;
pushing a cutting blade into an edge of the jacket; and
removing the cable from the longitudinal channel while the cutting blade is pushed into the edge.

25. The process for longitudinally slitting a jacket of a flat cable of claim 24 further comprising:
pushing a second cutting blade into an opposing edge of the jacket; and
removing the cable from the longitudinal channel while the second cutting blade is pushed into the opposing edge.

26. The process for longitudinally slitting a jacket of a flat cable of claim 24 wherein the pushing is done by the thumb of a human.

27. The process for longitudinally slitting a jacket of a flat cable of claim 24 wherein the cable is moved in a direction with respect to the longitudinal channel during the removing that is opposite of the direction it is move with respect to the longitudinal channel during the inserting.

28. A process for longitudinally slitting a jacket of a flat cable comprising:
inserting the cable into a longitudinal channel;
pushing a cutting blade into the jacket; and
removing the cable from the longitudinal channel while the cutting blade is pushed into the jacket.
